(19) United States
(12) Patent Application Publication
(10) Pub. No.: US 2020/0031173 A1
(43) Pub. Date: Jan. 30, 2020

(54) RADAR TREAD SENSING FOR WHEEL WELL

(71) Applicant: Just Wheels & Tires Co., Brea, CA (US)

(72) Inventor: Terence Scheckter, Brea, CA (US)

(73) Assignee: Just Wheels & Tires Co., Brea, CA (US)

(21) Appl. No.: 16/516,340

(22) Filed: Jul. 19, 2019

Related U.S. Application Data
(60) Provisional application No. 62/711,664, filed on Jul. 30, 2018.

(51) Int. Cl. B60C 11/24

(52) U.S. Cl. CPC B60C 11/243; B60C 11/246

(57) ABSTRACT

The present subject matter generally concerns the detection of tire tread using a sensor attached to the underside of the wheel well of a vehicle. More particularly, the present disclosure relates to methods and apparatus for the detection of tread wear on a tire. The signal analysis used measures the tread wear on the tire and transmits that information. A system for determining tread wear of a tire includes a first wireless communication chip located in a sensor attached to the wheel well of the vehicle.

### CROSS REFERENCE TO RELATED APPLICATIONS

The present invention claims priority to U.S. Provisional Application 62/711,664 filed Jul. 30, 2018.

### FIELD OF THE INVENTION

The current invention relates generally to determining the tread wear of a tire. More specifically, it relates to a system and method for real-time determination of the tread wear of a tire and the transmission of that information to the owner of the vehicle and potentially tire vendors.

### BACKGROUND OF THE INVENTION

Tires are made with a tread. This tread makes contact with the road. Grooves in the tread of the tire, typically referred to as the tread pattern, are designed with the purpose of providing traction for the vehicle. As a tire is used, this tread is worn down and therefore the tire becomes less effective and safe.

As such, it is important to monitor the tread wear of tires. Tires can lose tread in unequal amounts in different wheels on one vehicle. Having this knowledge would allow the owner of the vehicle to either rotate their tires, or when necessary, replace the tires when all of them have a sufficiently worn-down tread.

Accordingly, vehicle owners should monitor tread wear by a visual check and/or by a direct measurement of the depth of the tire tread to make sure that there is adequate tread to make their vehicle safe. Having this knowledge would allow those drivers to maintain their safety and the safety of others on the road. Unfortunately, measuring tread wear is an often-neglected aspect of vehicle ownership. This leads tires to be used after the end of their service life. Driving on tires that are past their service life can unnecessarily place the driver of the vehicle, its passengers, and others in a dangerous driving situation.

These and additional features provided by the embodiments described herein will be more fully understood in view of the following detailed description, in conjunction with the drawings.

### BRIEF DESCRIPTION OF THE FIGURES

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIGS. 1 and 2 illustrate the invention and the sensor feedback;

FIG. 3 is a system diagram of the vehicle with the sensor system and communication network.

### DETAILED DESCRIPTION OF THE INVENTION

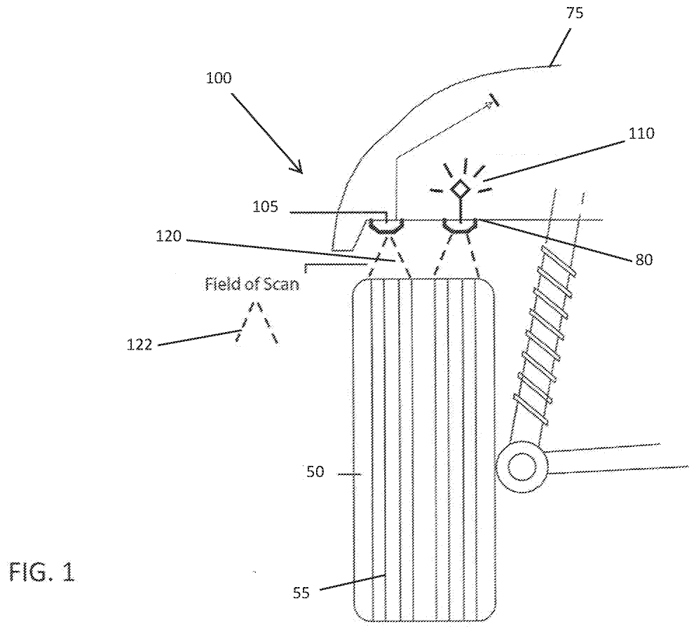

Referring now to FIGS. 1-3, there is described and disclosed a tire wear state estimation system 100 that includes a tire 50 supported by a wheel that supports a vehicle 75 and at least one sensor 105 for measuring tread wear 55 on the tire 50. The system for determining tread wear of a tire further a transmitter 110 configured to be installed inside the wheel well 80 of a vehicle 75 above the tire 50 to sense and transmit at least partially a characteristic of the tire.

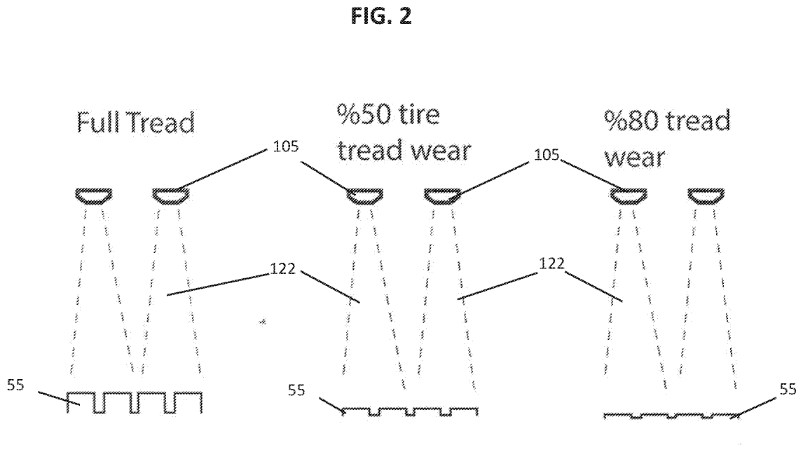

The system for determining tread wear of a tire 100 further includes a sensor 105 configured to be installed inside the wheel well of the vehicle. The system for determining tread wear of a tire further entails the sensor 105 transmitting a signal 120 (field of scan 122) to the tire 50 and measuring the tread 55 of the tire as the tire is in motion. The system for determining tread wear of a tire 100 is further configured such that the signal 120 transmitted to the tire reads the difference between the high and low point of the tire across multiple locations on the tire as it rolls. As illustrated in FIG. 2, the difference between measurements of the signal(s) that is indicative of the remaining tread on the tire. This is typically compared to either a baseline distance or simply the distance being within a certain range to indicate the wear. The system further includes a receiver unit in the car that is in wireless communication with said the sensor or transmitter. The receiver unit is configured to receive a tread wear signal from the sensor and have programming to determine the tread wear from the signal, wherein the tread wear signal is indicative of said tread wear. A communication unit is coupled to the receiver unit and is configured to provide information to a user regarding the tread wear of the tire.

The system 100 for determining tread wear of a tire is installed in the vehicle 75 during vehicle production as an original equipment or as an after-market product. The system for determining tread wear of a tire may be connected into the dashboard and configured to provide the owner of the vehicle with an alert when tread is sufficiently low such that the tire needs replacement. The system for determining tread wear of a tire may be configured to relay information regarding when a tire's tread is sufficiently low wirelessly to the vehicle owner's mobile device through an electronic application downloaded on the phone. The system for determining tread wear of a tire may be further configured to relay information regarding when a tire's tread is sufficiently low such that it requires replacement to a cloud-based service. The system for determining tread wear of a tire may then provide the information measured by the device to tire vendors such that the vendor may market to vehicle owners.

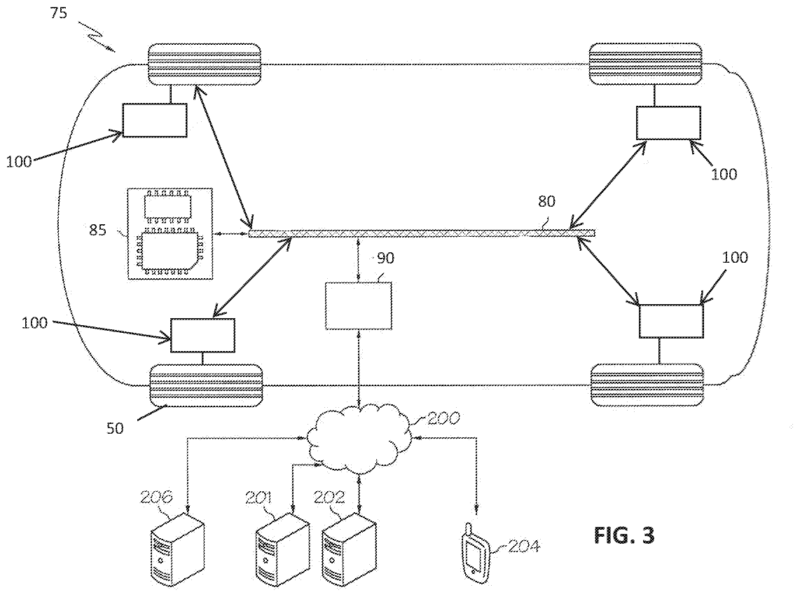

Referring now to FIG. 3, an embodiment of a system 100 comprising a vehicle 75 and a vendor interaction system 201. The vehicle 75 may comprise a communication path 80 that provides data interconnectivity between various vehicle modules disposed within the vehicle 75. Accordingly, the communication path 80 communicatively couples any number of vehicle modules with one another and allows the vehicle modules to operate in a distributed computing environment. Specifically, each of the vehicle modules can operate as a node that may send and/or receive data. In one embodiment, the communication path may be wireless or, alternatively, an optical waveguide, communication bus, or plug and play.

The vehicle 75 generally comprises input/output hardware communicatively coupled with the communication path 80, such as the system 100. The input/output hardware serves as an interconnection between a driver and the vehicle 75. The input/output hardware can be any device capable of transforming mechanical, optical, or electrical signals into a data signal capable of being transmitted with the communication path 84. Moreover, the input/output hardware can be any device capable of transforming a data signal into a mechanical, optical, or electrical output. Each individual component of the input/output hardware can optionally include one or more processors and one or more memories. Alternatively, each individual component of the input/output hardware can optionally omit a processor and/or a memory. Accordingly, it is noted that, while specific components are described herein as including a processor and/or a memory, the embodiments described herein should not be so limited.

The input/output hardware can include one or more displays 85 for visually presenting data. The one or more displays 85 can be located throughout the vehicle 75 and can include any medium capable of transmitting an optical output such as, for example, a cathode ray tube, light emitting diodes, liquid crystal displays, plasma displays, or the like. Each of the one or more displays 85 can be a touchscreen that, in addition to providing optical information, detects the presence and location of a tactile input upon a surface of or adjacent to the display. Accordingly, each display 8 can receive mechanical input directly upon the optical output provided by the display 85.

Moreover, information gathered from the system(s) 100 can be distributed over the communication network 80 and then transmitted by a vehicle transmitter 90 over a network 200 that may include one or more cellular networks, satellite networks and/or computer networks such as, for example, a wide area network, a local area network, personal area network, a global positioning system and combinations thereof. Accordingly, the vehicle 75 can be communicatively coupled to the network 200 via wires, via a wide area network, via a local area network, via a personal area network, via a cellular network, via a satellite network and the like. Suitable local area networks may include wired ethernet and/or wireless technologies such as, for example, Wi-Fi. Thus, any components of the vehicle 102 can utilize one or more network components to transmit signals over the Internet or World Wide Web.

In one embodiment, the vehicle 75 comprises network interface hardware 90 for communicatively coupling the vehicle 75 with the network 200. The network interface hardware 150 can be communicatively coupled to the communication path 80 and can be any device capable of transmitting and/or receiving data via the network 200. Accordingly, the network interface hardware 90 can include an antenna and/or other communication transceiver for sending and/or receiving any wired or wireless communication.

The network 200 can communicatively couple the vehicle 75 to other devices in a flexible client-server relationship, i.e., the vehicle 75 can be a server to and/or a client of any device communicatively coupled to the vehicle 75 via the network 200. Specifically, the network 200 can be configured to enable the delivery of cloud resources to and/or from the vehicle 75. Any device communicatively coupled to the vehicle 75 can deliver a cloud resource to the vehicle 75 via the network 200. Similarly, the vehicle 75 can deliver a cloud resource via the network 200 to any device communicatively coupled to the vehicle 75. Accordingly, cloud resources such as, for example, processing, storage, software, and information can be shared via the network 200.

Still referring to FIG. 3, the network 200 may be utilized to communicatively couple a vehicle 75, one or more remote computing devices 202, one or more mobile devices 204, one or more vendor interaction systems 201, and one or more home computing devices 206. Accordingly, each of the vehicle 102, one or more remote computing devices 202, the one or more mobile devices 204, one or more vendor interaction systems 201, and the one or more home computing devices 206 can be communicatively coupled to one another directly or indirectly via the network 200.

The networked may comprise one or more vendor interaction systems 201 communicatively coupled to the vehicle 75 via the network 200. The vendor interaction system 201 may comprise a vendor computing device. Each of the one or more vendor computing devices can comprise one or more processors and one or more memories. A vendor, as used herein, may be any person, persons, business entity, and the like, who sell or distribute goods or provide services. For example, vendors may a new or used tire company or autobody shop, and/or the vehicle manufacturer.

The system 100 is thus able to communicate the tire tread wear pattern to the vehicle 75 through the communication pathway 80 and then display the information to the user through a dash or heads up display 85 and through a user's mobile 204. Moreover, if configured, the system 100 could then send the data to a vender 202. The vender could then communicate with the vehicle owner, either through the display 85 or mobile 204 to provide information on replacement tires.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

I claim:

1. A tire wear state estimation system comprising: a tire supported by a wheel and supporting a vehicle; a sensor for measuring tread wear on a tire.

2. The system for determining tread wear of a tire in claim 1, comprising: a transmitter configured to be installed inside the wheel well of a vehicle above the tire to sense and transmit at least partially a characteristic of the tire.

3. The system for determining tread wear of a tire in claim 1 comprising: a sensor configured to be installed inside the wheel well of the vehicle.

4. The system for determining tread wear of a tire in claim 1, entails the sensor transmitting a signal to the tire and measuring the tread of the tire as the tire rolls.

5. The system for determining tread wear of a tire in claim 5, wherein the signal transmitted to the tire reads the difference between the high and low point of the tire across multiple locations on the tire as it rolls.

6. The system for determining tread wear of a tire in claim 5, wherein the difference between the two measurements of said signal is indicative of the remaining tread on the tire.

7. The system of claim 1 further comprising: a receiver unit in wireless communication with said the sensor, said receiver unit being configured to receive a tread wear state signal from said sensor element, said tread wear state signal being indicative of said tread wear; and a communication unit coupled with said receiver unit, said communication unit being configured to provide information to a user regarding said tread wear of said tire.

8. The system for determining tread wear of a tire in claim 1, wherein the system is installed in the vehicle during vehicle production as an original equipment or as an after-market product.

9. The system for determining tread wear of a tire in claim 8, wherein the system may be wired in to the dashboard and configured to provide the owner of the vehicle with an alert when tread is sufficiently low such that the tire needs replacement.

10. The system for determining tread wear of a tire in claim 8, wherein when the system is configured to relay information regarding when a tire's tread is sufficiently low such that it needs replacement wirelessly to the vehicle owner's phone through an electronic application.

11. The system for determining tread wear of a tire in claim 10, wherein the system is configured to relay information regarding when a tire's tread is sufficiently low such that it requires replacement to a cloud-based service.

12. The system for determining tread wear of a tire in claim 12, wherein the information measured by the device is further communicated to a third-party tire vendor to send information to a vehicle owner.
